(19) United States
(12) Patent Application Publication
(10) Pub. No.: US 2018/0064039 A1
(43) Pub. Date: Mar. 8, 2018

(54) PLANT PROTECTOR

(71) Applicants: Laura Boyd, Grande Prairie (CA); Greg Boyd, Grande Prairie (CA)

(72) Inventors: Laura Boyd, Grande Prairie (CA); Greg Boyd, Grande Prairie (CA)

(21) Appl. No.: 15/256,519

(22) Filed: Sep. 3, 2016

(51) Int. Cl. A01G 13/02

(52) U.S. Cl. CPC A01G 13/0281; A01G 13/0212

(57) ABSTRACT

A plant protector can include a plurality of vertical members, a first ring member, and a handle assembly. The plurality of vertical members can extend along respective arcuate paths between respective bottom ends and respective top ends. The bottom ends can be spaced about a bottom periphery and the top ends can be spaced about a top periphery. A plurality of the plant protectors are stackable on one another with the top periphery of an upper plant protector receivable in the bottom periphery of a lower plant protector. The first ring member can interconnect the top ends of the plurality of vertical members. The handle assembly can include a second ring member and a handle mounted on the second ring member. The second ring member can be releasibly engageable with the first ring member.

### BACKGROUND

### 1. Field

The present disclosure relates to a structure for protecting plants from, for example, cold weather that can result in frost.

### 2. Description of Related Prior Art

U.S. Pat. Pub. No. 2007/0186466 discloses a PLANT PROTECTIVE COVER SYSTEM WITH COLLAPSIBLE RIGID FRAME. The '466 publication alleges to teach methods, systems, apparatus, and devices for providing protection for outdoor plants against the elements, and for regulation of climactic conditions for both indoor and outdoor plants. The '466 publication alleges to provide methods and apparatus for covering growing plants to protect them from the elements, and to a freestanding rigid but collapsible frame and a fitted protective cover for use, for example, in cultivated agricultural fields, farmlands, and indoor spaces.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A plant protector can include a plurality of vertical members, a first ring member, and a handle assembly. The plurality of vertical members can be spaced from one another about a central longitudinal axis and extend along respective arcuate paths between respective bottom ends and respective top ends. The bottom ends can be spaced about a bottom periphery having a first diameter and the top ends can be spaced about a top periphery having a second diameter less than the first diameter whereby a plurality of the plant protectors are stackable on one another with the top periphery of an upper plant protector receivable in the bottom periphery of a lower plant protector. The first ring member can be fixedly engaged with and rigidly interconnect the top ends of the plurality of vertical members to define a first opening. The handle assembly can include a second ring member and a handle mounted on the second ring member. The second ring member can be releasibly engageable with the first ring member to permit selective attachment of the handle with the plurality of vertical members.

### BRIEF DESCRIPTION OF THE DRAWINGS

The detailed description set forth below references the following drawings:

FIG. 1 is an exploded view of an exemplary embodiment of the present disclosure;

FIG. 2 is a side view of a radially-outer side of a second ring member according to the first exemplary embodiment of the present disclosure as if straightened;

FIG. 3 is a side view of a radially-inner side of a first ring member according to the first exemplary embodiment of the present disclosure as if straightened;

FIG. 4 is a cross-section through first and second ring members interconnected with one another with threads according to another exemplary embodiment of the present disclosure;

FIG. 5 is a cross-section through first and second ring members interconnected with one another with magnetism according to another exemplary embodiment of the present disclosure;

FIG. 6 is a top-down view of portions of first and second ring members of the first exemplary embodiment; and

FIG. 7 is a magnified view of a portion of another exemplary embodiment of the present disclosure having telescoping vertical members.

### DETAILED DESCRIPTION

A plurality of different embodiments of the present disclosure is shown in the Figures of the application. Similar features are shown in the various embodiments of the present disclosure. Similar features across different embodiments have been numbered with a common reference numeral and have been differentiated by an alphabetic suffix. Similar features in a particular embodiment have been numbered with a common two-digit, base reference numeral and have been differentiated by a different leading numeral. Also, to enhance consistency, the structures in any particular drawing share the same alphabetic suffix even if a particular feature is shown in less than all embodiments. Similar features are structured similarly, operate similarly, and/or have the same function unless otherwise indicated by the drawings or this specification. Furthermore, particular features of one embodiment can replace corresponding features in another embodiment or can supplement other embodiments unless otherwise indicated by the drawings or this specification.

The present disclosure, as demonstrated by the exemplary embodiments described below, can provide a plant protector that is strong and robust, stackable, one-piece, and also easily deployed. In one or more embodiments of the present disclosure, one or more plant protectors can be retrieved from a stack of the plant protectors. Less than the full stack of plant protectors can be retrieved easily. One or more embodiments of the present disclosure can include a clasping ring with an over-center latch, which allows for easy application of an interchangeable frost covering. One or more embodiments of the present disclosure can be solid, rigid and durable frame that can be used repeatedly. One or more embodiments of the present disclosure can include a frame that can be easy and quick to deploy and put in use. One or more embodiments of the present disclosure can include a handle that folds over and allows for stackability. The handle can twist and lock into place for easy use. One or more embodiments of the present disclosure can include a handle that allows for easy deployment and use. One or more embodiments of the present disclosure can include a frame that allows for stackability similar to Russian dolls. One or more embodiments of the present disclosure can allow for stackability and storage in a small place. One or more embodiments of the present disclosure can have extendible legs. One or more embodiments of the present disclosure can include rings on the bottom to assist in securing the frame to the ground when necessary. One or more embodiments of the present disclosure can define a simple design that allows for use by the elderly and the young.

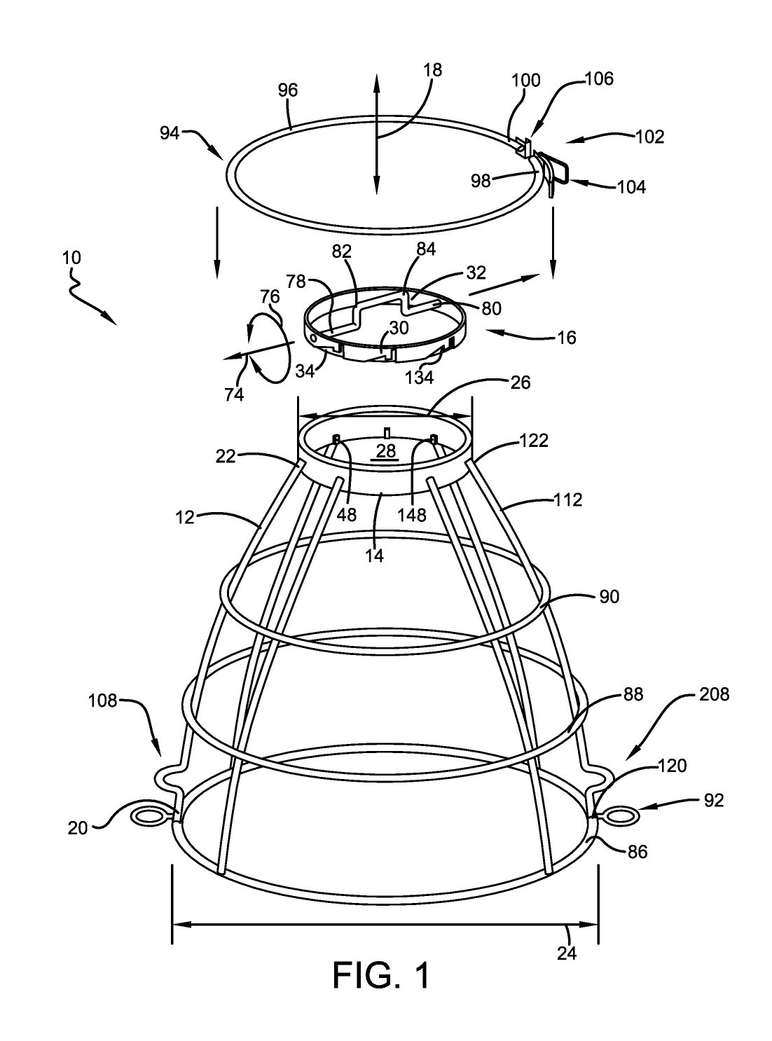

Referring now to FIG. 1, a plant protector 10 can include a plurality of vertical members such as 12 and 112, a first ring member 14, and a handle assembly 16. The plurality of vertical members 12, 112 can be spaced from one another about a central longitudinal axis 18 and extend along respective arcuate paths between respective bottom ends such as 20 and 120 and respective top ends 22 and 122. The bottom ends 20, 120 can be spaced about a bottom periphery having a first diameter 24 and the top ends 22, 122 can be spaced about a top periphery having a second diameter 26 less than the first diameter 24 whereby a plurality of the plant protectors 10 are stackable on one another with the top periphery of an upper plant protector 10 receivable in the bottom periphery of a lower plant protector 10.

The first ring member 14 can be fixedly engaged with and rigidly interconnect the top ends 22, 122 of the plurality of vertical members 12, 112 to define a first opening 28. The handle assembly 16 can include a second ring member 30 and a handle 32 mounted on the second ring member 30. The second ring member 30 can be releasibly engageable with the first ring member 14 to permit selective attachment of the handle 32 with the plurality of vertical members 12, 112.

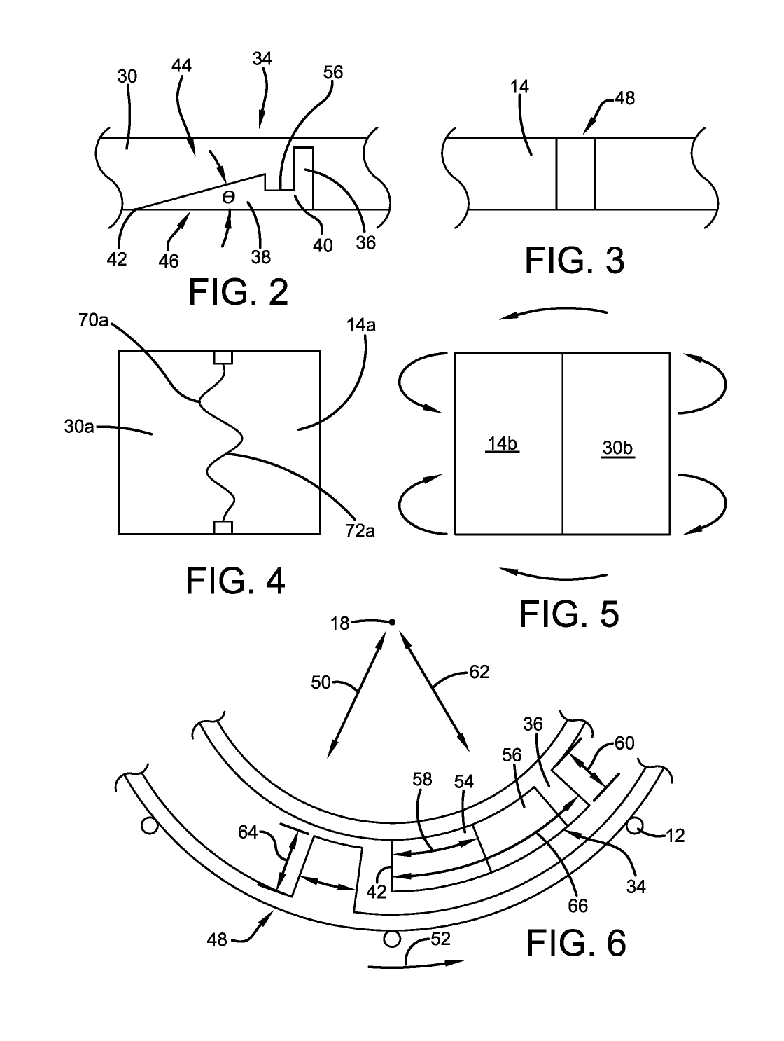

The exemplary plant protector 10 also includes a plurality of locking arms such as 34 and 134 each fixedly associated with one of the first ring member 14 and the second ring member 30. The exemplary locking arms 34, 134 are fixedly associated with the second ring member 30 but could be fixedly associated with the first ring member 14 in other implementations of the present disclosure. As best shown in FIG. 2, each of the plurality of locking arms 34, 134 include an axial portion 36 extending along the central longitudinal axis 18 and a circumferential portion 38 extending about the central longitudinal axis 18. Each of the circumferential portions 38 can extend from a first end 40 at an intersection with one of the axial portions 36 to a respective second end 42 distal relative to the first end. Each of the circumferential portions 38 can have an upper face 44 and a lower face 46.

Referring again to FIG. 1, the exemplary plant protector 10 also includes a plurality of tabs such as 48 and 148 each fixedly associated with the first ring member 14. The exemplary tabs 48, 148 are fixedly associated with the first ring member 14 but could be fixedly associated with the second ring member 30 in other implementations of the present disclosure. Each of the plurality of tabs 48, 148 can extend away from the first ring member 14 along a respective tab axis (referenced at 50 in FIG. 6) that intersects the central longitudinal axis 18. The first ring member 14 and the handle assembly 16 are interconnected by moving each of the plurality tabs 48, 148 past each of the plurality of second ends 42 along the central longitudinal axis 18 and then rotating the first ring member 14 and the second ring member 30 relative to one another in a first angular direction about the central longitudinal axis 18 and sliding each of the plurality of tabs 48, 148 along one of the upper and lower faces 44, 46 such that the one of the upper and lower faces 44, 46 thereby defines a sliding surface. In the exemplary embodiment, the tab 48 can be moved in the angular direction referenced at 52 and slid along the upper face 44. The upper face 44 thus defines the sliding surface in the exemplary embodiment.

The exemplary sliding surface 44 includes a ramp portion 54 and a notch portion 56. The exemplary ramp portion 54 has a first rate of incline θ and extends about the central longitudinal axis 18 a first angular distance 58. The notch portion 56 can be sized to receive the tab 48. The tab 48 is slidable initially along the ramp portion 54 and is then received in the notch portion 56 during relative rotation between the first ring member 14 and the second ring member 30 in the first angular direction 52.

Each of the plurality of locking arms 34, 134 defines a radial thickness along a respective arm axis that intersects the central longitudinal axis 18. In FIG. 6, the radial thickness of locking arm 34 is referenced at 60 and the arm axis of locking arm 34 is referenced at 62. Each of the plurality of tabs 48, 148 defines a radial thickness along the respective tab axis. In FIG. 6, the radial thickness of tab 48 is referenced at 64 and the tab axis of tab 48 is referenced at 50. The radial thickness 60 of the plurality of arms 34, 134 is substantially equal to the radial thickness 64 of the plurality of tabs 48, 148 in the exemplary embodiment.

Each of the plurality of locking arms 34, 134 defines a radial width about the central longitudinal axis 18. The radial width of the locking arm 34 is referenced at 66 in FIG. 6. Each of the plurality of tabs 48, 148 defines a radial width about the central longitudinal axis 18. The radial width of the tab 48 is referenced at 68 in FIG. 6. The plurality of locking arms 34, 134 and the plurality of tabs 48, 148 can be sized such that all of the plurality of locking arms 34, 134 and all of the plurality of tabs 48, 148 are positionable circumferentially adjacent to one another in alternating relation inside of the first ring member 14. Further, the exemplary plurality of locking arms 34, 134 and the exemplary plurality of tabs 48, 148 are sized such that all of the plurality of locking arms 34, 134 and all of the plurality of tabs 48, 148 are positionable circumferentially adjacent to one another in alternating relation outside of the second ring member 30. The arrangement in the exemplary embodiment results in the second ring member 30 and the plurality of locking arms 34, 134 being sized to pass through the first ring member 14 along the central longitudinal axis 18 when the plurality of tabs 48, 148 and the plurality of locking arms 34, 134 are offset from one another about the central longitudinal axis 18. This allows the handle assembly 16 to be lowered down into a stack of the plant protectors 10. For example, if a user desires to deploy four plant protectors 10 from a stack of ten plant protectors 10, the user can lower the handle assembly 16 down through the first openings of the top three plant protectors 10 without interference from the top three plant protectors 10 and engage the first ring member the fourth plant protector 10.

FIG. 4 is an alternative embodiment of the present disclosure in which respective threads 70a, 72a on a first ring member 14a and a second ring member 30a releasibly interconnect the first ring member 14a and the second ring member 30a. FIG. 5 is another alternative embodiment of the present disclosure in which at least one of a first ring member 14b and a second ring member 30b is magnetized and thereby configured to engage the other of the first ring member 14b and the second ring member 30b magnetically.

Referring again to FIG. 1, the handle 32 can be pivotally engaged with the second ring member 30. The exemplary handle 32 and the exemplary second ring member 30 are arranged such that the handle 32 is operable to rotate 360° about an axis 74. The directions of rotation are referenced at 76. The exemplary handle 32 includes a first post portion 78 centered on and rotatable about the pivot axis 74 and extending from a first side of the second ring member 30. The exemplary handle 32 also includes a second post portion 80 centered on and rotatable about the pivot axis 74 and extending from a second side of the second ring member 30 opposite the first side. The exemplary handle 32 also includes an arcuate portion 82 extending between the first post portion 78 and the second post portion 80. The exemplary arcuate portion 82 has a portion 84 defining a maximum distance from the central longitudinal axis 18. For example, in FIG. 1 the handle 32 is oriented vertically, but when the handle 32 is oriented laterally or to the side, the portion 84 is the part of the handle 32 furthest from the axis 18. The maximum distance is less than a radius of the second ring member 30 so that the handle 32 is not prevented from turning by the second ring member 30.

The exemplary plant protector 10 also includes a third ring member 86 fixedly engaged with and interconnecting the bottom ends 20, 120 of the plurality of vertical members 12, 112 and defining a second opening for receiving a plant. The exemplary plant protector 10 also includes a fourth ring member 88 fixedly engaged with and interconnecting the plurality of vertical members 12, 112 at a position along the central longitudinal axis 18 between the first ring member 14 and the third ring member 86. The exemplary plant protector 10 also includes a fifth ring member 90 fixedly engaged with and interconnecting the plurality of vertical members 12, 112 at a position along the central longitudinal axis 18 between the first ring member 14 and the fourth ring member 88. The plurality of vertical members 12, 112, the first ring member 14, the third ring member 86, the fourth ring member 88, and the fifth ring member 90 can be steel components welded together. The plurality of vertical members 12, 112, the first ring member 14, the third ring member 86, the fourth ring member 88, and the fifth ring member 90 can be steel rod bended as desired.

The exemplary plant protector 10 also includes at least one anchoring ring 92 having a smaller diameter than the bottom periphery. It is noted that the ring member 86 extends along the bottom periphery. The anchoring ring 92 can be fixedly engaged with respect to one of the plurality of vertical members 12, 112 through the ring member 86.

The exemplary plant protector 10 also includes an annular clamp 94. The clamp 94 can be utilized when a flexible sheet such as plastic or cloth is draped over the cage defined by the members 12, 112 and various ring members. The clamp 94 can include a discontinuous ring portion 96 extending along an arcuate path between a first end 98 and a second end 100. The clamp 94 can also include an over-center latch 102 with a first portion 104 engaged with the first end 98 and a second portion 106 engaged with the second end 100. The over-center latch 102 is configured to selectively draw and lock the first and the second ends 98, 100 together to retain the flexible sheet over the cage. The members 12 and 112 can include respective bends, such as referenced at 108 and 208, to retain the clamp 94 in place on the cage.

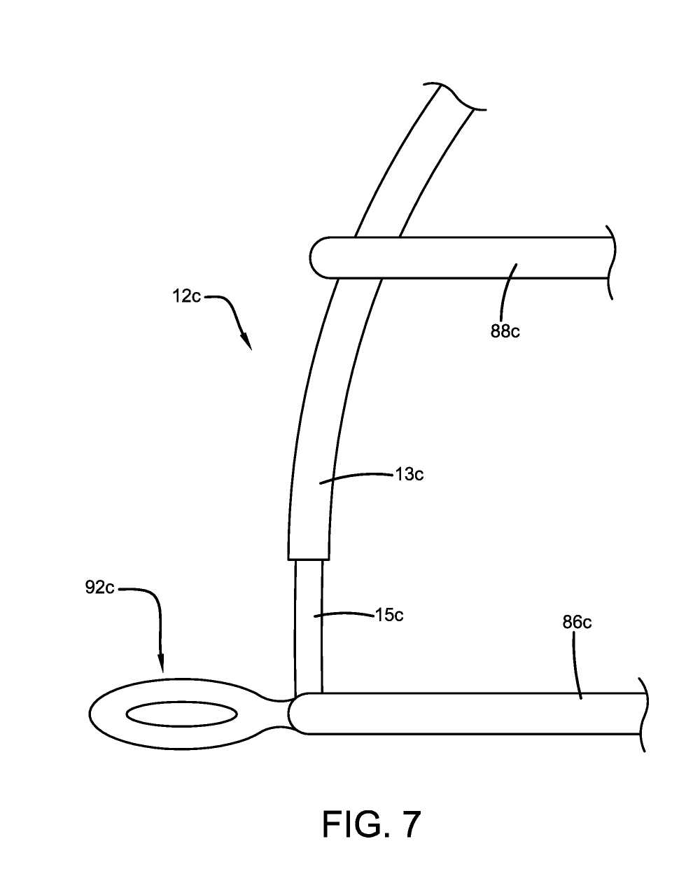

FIG. 7 is a magnified view of a portion of another exemplary embodiment of the present disclosure having telescoping vertical members. An exemplary vertical member 12c can be connected to a third ring member 86c and a fourth ring member 88c. An anchoring ring 92c can also be connected to the third ring member 86c. The vertical member 12c can include first and second members 13c and 15c that are engaged with one another telescopically. The first and second members 13c and 15c can be sized and configured so that they do not slide freely with respect to one another; in this way, the member 15c can be pulled out of the member 13c to the desired height and the members 13c, 15c will remain at the desired height. This can be accomplished by making the inner surface of the member 13c or the outer surface of the member 15c relatively rough to increase the coefficient of friction between the members 13c, 15c. Alternatively, supplemental clips can be included for positioning on the member 15c and can be too large to be received in the member 13c.

While the present disclosure has been described with reference to an exemplary embodiment, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the appended claims. The right to claim elements and/or sub-combinations that are disclosed herein as other present disclosures in other patent documents is hereby unconditionally reserved.

What is claimed is:

1. A plant protector comprising:
a plurality of vertical members spaced from one another about a central longitudinal axis and extending along respective arcuate paths between respective bottom ends and respective top ends, said bottom ends spaced about a bottom periphery having a first diameter and said top ends spaced about a top periphery having a second diameter less than said first diameter whereby a plurality of said plant protectors are stackable on one another with said top periphery of an upper plant protector receivable in said bottom periphery of a lower plant protector;
a first ring member fixedly engaged with and rigidly interconnecting said top ends of said plurality of vertical members to define a first opening; and
a handle assembly including a second ring member and a handle mounted on said second ring member, wherein said second ring member is releasibly engageable with said first ring member to permit selective attachment of the handle with the plurality of vertical members.

2. The plant protector of claim 1 further comprising:
a plurality of locking arms each fixedly associated with one of said first ring member and said second ring member, each of said plurality of locking arms including an axial portion extending along said central longitudinal axis and a circumferential portion extending about said central longitudinal axis, each of said circumferential portions extending from a first end at an intersection with one of said axial portions to a respective second end distal relative to said first end, and each of said circumferential portions having an upper face and a lower face.

3. The plant protector of claim 2 further comprising:
a plurality of tabs each fixedly associated with the other of said first ring member and said second ring member, each of said plurality of tabs extending away from said other of said first ring member and said second ring member along a respective tab axis that intersects said central longitudinal axis, wherein said first ring member and said handle assembly are interconnected by moving each of said plurality tabs past each of said plurality of second ends along said central longitudinal axis and then rotating said first ring member and said second ring member relative to one another in a first angular direction about said central longitudinal axis and sliding each of said plurality of tabs along one of said upper and lower faces such that said one of said upper and lower faces thereby defines a sliding surface.

4. The plant protector of claim 3 wherein said sliding surface further comprises:
a ramp portion having a first rate of incline and extending about said central longitudinal axis a first angular distance; and
a notch portion sized to received one of said plurality of tabs, said one of said plurality of tabs slidable initially along said ramp portion and then received in said notch portion during relative rotation between said first ring member and said second ring member in said first angular direction.

5. The plant protector of claim 3 wherein each of said plurality of locking arms defines a radial thickness along a respective arm axis that intersects said central longitudinal axis, wherein each of said plurality of tabs defines a radial thickness along said respective tab axis, and wherein said radial thickness of said plurality of arms is substantially equal to said radial thickness of said plurality of tabs.

6. The plant protector of claim 3 wherein each of said plurality of locking arms defines a radial width about said central longitudinal axis, wherein each of said plurality of tabs defines a radial width about said central longitudinal axis, and wherein said plurality of locking arms and said plurality of tabs are sized such that all of said plurality of locking arms and all of said plurality of tabs are positionable circumferentially adjacent to one another in alternating relation inside of said first ring member.

7. The plant protector of claim 6 wherein said plurality of locking arms and said plurality of tabs are further defined as sized such that all of said plurality of locking arms and all of said plurality of tabs are positionable circumferentially adjacent to one another in alternating relation outside of said second ring member.

8. The plant protector of claim 7 wherein said second ring member and said one of said plurality of tabs and said plurality of locking arms that is fixedly engaged with said second ring member are sized to pass through said first ring member along said central longitudinal axis when said plurality of tabs and said plurality of locking arms are offset from one another about said central longitudinal axis.

9. The plant protector of claim 1 further comprising:
respective threads on said first ring member and said second ring member wherein said first ring member and said second ring member are interconnected through said respective threads.

10. The plant protector of claim 1 wherein at least one of said first ring member and said second ring member is magnetized and thereby configured to engage the other of said first ring member and said second ring member magnetically.

11. The plant protector of claim 1 wherein said handle is further defined as pivotally engaged with said second ring member.

12. The plant protector of claim 11 wherein said handle and said second ring member are arranged such that said handle is operable to rotate 360°.

13. The plant protector of claim 11 further wherein said handle is further defined as pivotable about a pivot axis and further comprises:
a first post portion centered on and rotatable about said pivot axis and extending from a first side of said second ring member;
a second post portion centered on and rotatable about said pivot axis and extending from a second side of said second ring member opposite said first side; and
an arcuate portion extending between said first post portion and said second post portion, said arcuate portion having a portion defining a maximum distance from said central longitudinal axis and said maximum distance being less than a radius of said second ring member.

14. The plant protector of claim 1 further comprising:
a third ring member fixedly engaged with and interconnecting said bottom ends of said plurality of vertical members and defining a second opening for receiving a plant.

15. The plant protector of claim 14 wherein said plurality of vertical members, said first ring member and said third ring member are further defined as steel and welded together.

16. The plant protector of claim 14 further comprising:
a fourth ring member fixedly engaged with and interconnecting said plurality of vertical members at a position along said central longitudinal axis between said first ring member and said third ring member.

17. The plant protector of claim 16 further comprising:
a fifth ring member fixedly engaged with and interconnecting said plurality of vertical members at a position along said central longitudinal axis between said first ring member and said fourth ring member.

18. The plant protector of claim 17 wherein said plurality of vertical members, said first ring member, said third ring member, said fourth ring member, and said fifth ring member are further defined as steel and welded together.

19. The plant protector of claim 1 further comprising
at least one anchoring ring having a smaller diameter than said bottom periphery and fixedly engaged with respect to one of said plurality of vertical members.

20. The plant protector of claim 1 further comprising:
an annular clamp including a discontinuous ring portion extending along an arcuate path between a first end and a second end and an over-center latch with a first portion engaged with said first end and a second portion engaged with said second end, said over-center latch configured to selectively draw and lock said first and said second ends together.
